(19) United States
(12) Patent Application Publication
(10) Pub. No.: US 2013/0055165 A1
(43) Pub. Date: Feb. 28, 2013

(54) Depth Adaptive Modular Graphical User Interface

(71) Applicant: Paul R. Ganichot, Tampa, FL (US)

(72) Inventor: Paul R. Ganichot, Tampa, FL (US)

(21) Appl. No.: 13/216,204

(22) Filed: Aug. 23, 2011

(51) Int. Cl. G06F 3/048

(52) U.S. Cl. 715/850

(57) ABSTRACT

This invention provides a computerized system's graphical user interface to display two-dimensional content based on a depth navigation allowing the user to navigate inward and outward through modules of content without horizontal or vertical scrolling. Display of said content follows specific arrangements or virtual projections onto animated three -or more- dimensional objects to maintain the navigation paradigm and circumvent horizontal and vertical scrolling.

### BACKGROUND OF THE INVENTION

Computerized display of two-dimensional content typically uses the two-dimension physical display of a monitor and requires users to scroll vertically and horizontally to display any piece of content that didn't directly fit in the physical monitor screen's real-estate. Depth navigation in computerized system's graphical user interfaces is typically implemented for three-dimensional content and primarily topographical features such as the Earth and other geographical locations.

The present invention relates to an improved data processing system and method for rendering two-dimensional content.

### SUMMARY OF THE INVENTION

This invention provides an improved depth navigation allowing the user to navigate inward and outward through modules of content; display of said content follows specific arrangements or virtual projections onto animated three-dimensional objects to maintain the navigation paradigm and circumvent horizontal and vertical scrolling.

It is thus a feature of at least one embodiment of the invention to implement content arrangements via relationships information technology best practices.

In the invention, the system operates to:
a. Extract content from arrangements such as lists, structures or other relevant processes.
b. Leverage one or more data retrieval algorithms to dynamically select content to display and adapt the behavior of modules.
c. Take into account contextual information when selecting content to display and modules behavior.
d. Manage the display of content and modules behavior via inward and outward without horizontal or vertical scrolling.
e. Optionally include relationships linking a lower level item back to a top level item therefore giving the user the impression of a circular navigation.

In some embodiments, navigation may be automated so that the display of content and modules behavior gets updated without user action, including:
a. Gradually navigating outward back out to top level after a certain amount of time
b. Leveraging timer parameters to automatically navigate inward on a module
c. Adjusting the inward and outward navigation level based on events -or lack of events- from physical interfaces such as mouse track wheel, mouse movements, keyboard entries, or retina interfaces
d. Triggering inward and outward navigation level adjustments automatically and continuously

The system further operates to:
a. Fragment content into components to be displayed in the modules.
b. Display a subset of two-dimensional content via one or more virtual projections onto one or more three-dimensional objects.
c. Provide means to animate either automatically or via user action the three-dimensional objects.
d. Include means to replace the above mentioned three-dimensional objects by objects of four or more dimensions.

An embodiment of this invention may include means to adapt modules and their content to users' habits, preferences, or configurations.

It is a feature of at least one embodiment of the invention for the modules to reuse screen real- estate within the main display window according to the inward and outward navigation.

Further, embodiments of this invention may leverage some modules for constant reference and display.

The invention further provides the means to link a subset of the modules to a context such as geographical, personal, social, technical, or cultural.

An embodiment of this invention may include means to display and animate content in different modules simultaneously.

Embodiments of this Invention may Include
a. Implementations using a multi-tier computerized system architecture.
b. Implementations using client side functionality.
c. Implementations using the internet, web browsers, and related technologies.
d. Implementations in which modules and content are stored in a repository made up of one or more databases and one or more file systems.

While the invention has been described in detail with specific reference to preferred embodiments thereof, it is understood that variations and modifications thereof may be made without departing from the spirit and scope of the invention.

### BRIEF DESCRIPTION OF THE DRAWINGS

FIG. 1: Example of a computer system window with representation of rendering axis and a combination of modules and content.
X: horizontal scrolling
Y: vertical scrolling
Z: depth scrolling

FIG. 2: Example of a top level display of a combination of modules and content.

FIG. 3: Example of a display of a combination of modules and content after an incremental depth scrolling.

FIG. 4: Example of a display of a combination of modules and content after depth scrolling to a specific content inside a module.

FIG. 5: Example of a top level display of a combination of modules and content with modules linked to a geographical context.

FIG. 6: Example of a display of a combination of modules and content with modules linked to a geographical context, after an incremental depth scrolling.

FIG. 7: Example of another top level display of a combination of modules and content using modules representing the different aspects of a context such as personal, technical, or cultural.

FIG. 8: Example of a display of a combination of modules and content using modules representing the different aspects of a context such as personal, technical, or cultural after an incremental depth scrolling.

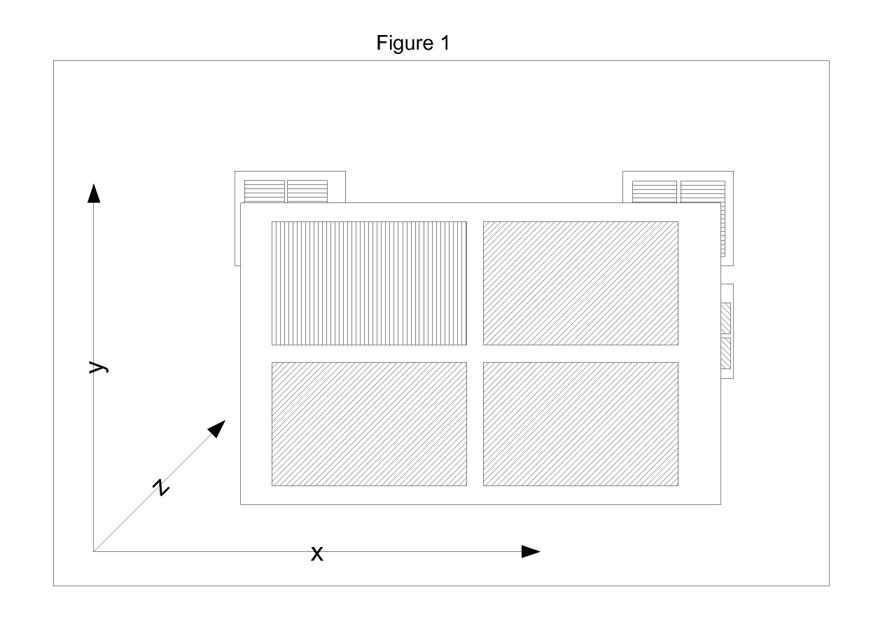

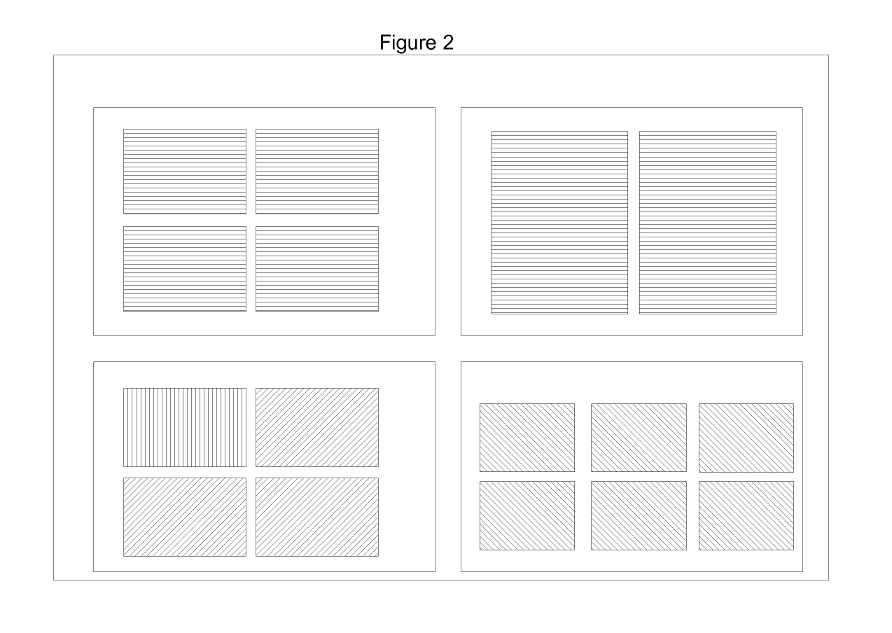

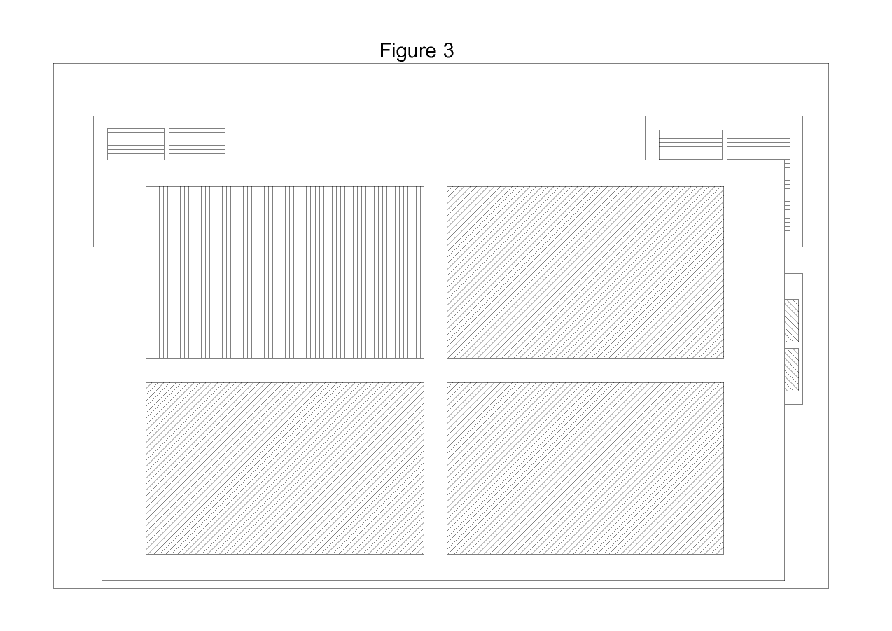

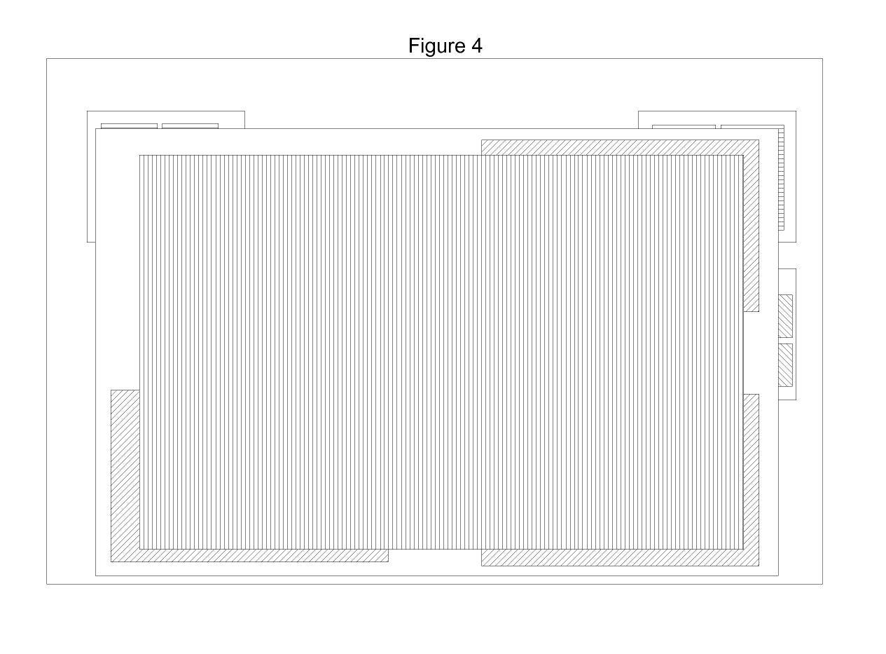

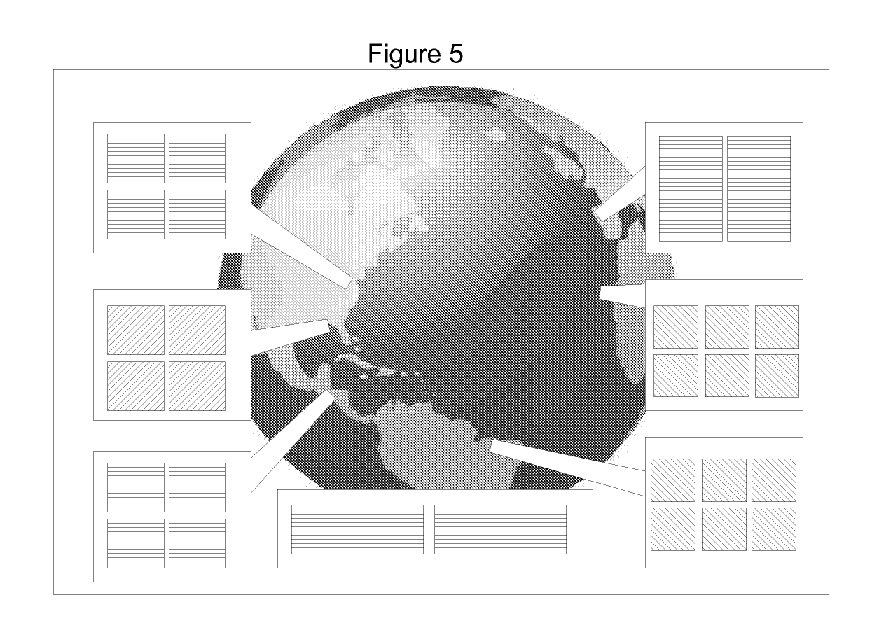

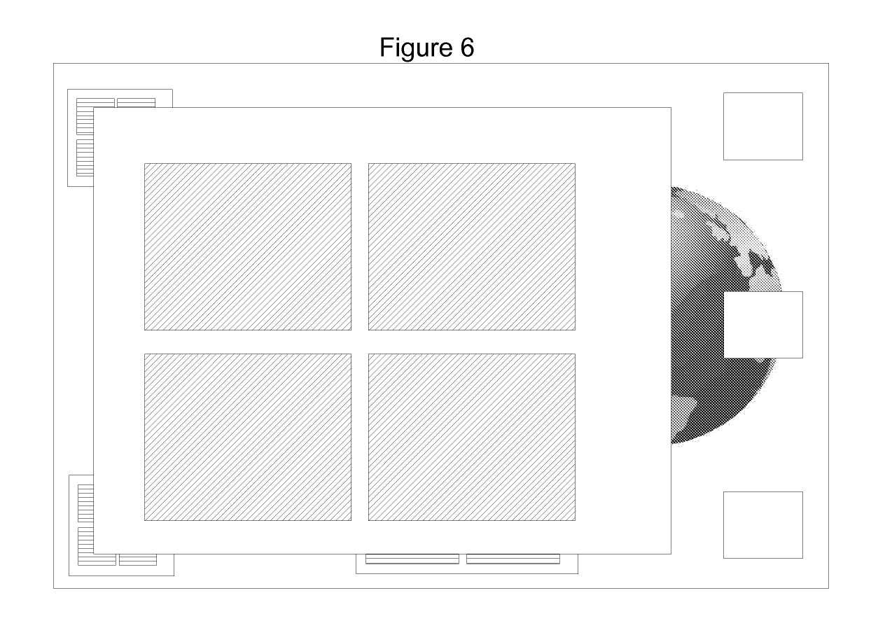

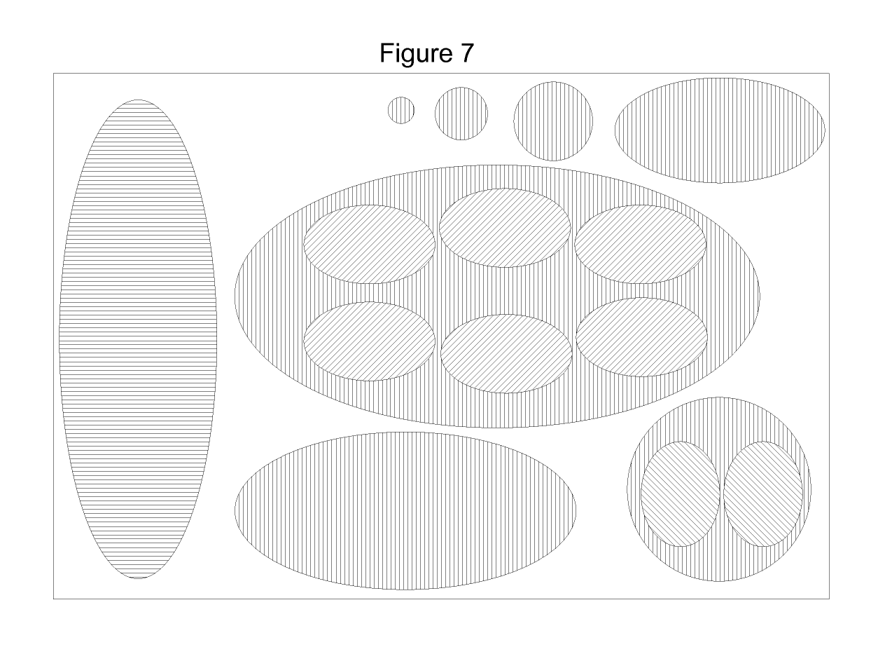

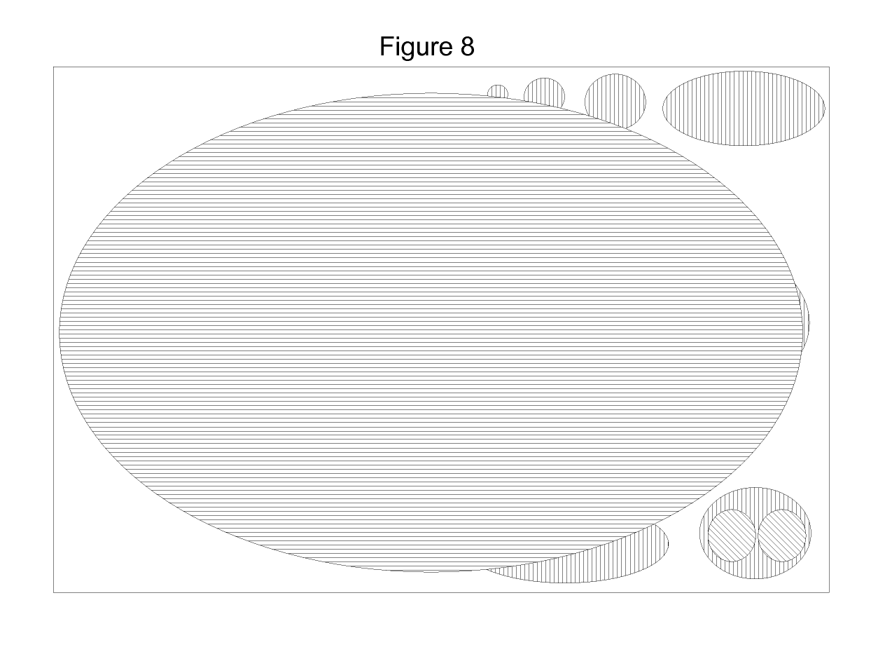

What is claimed is:

1. A computerized system's graphical user interface to display two-dimensional content consisting of a depth user navigation interface paradigm where users navigate inward and outward through content modules without horizontal or vertical scrolling.

2. The system of claim 1 including means for modules to dynamically display content based on arrangements of said content, context, algorithms, lists, and other relevant processes.

3. A system according to claim 2 including means to automatically update the displayed modules and content such as:
a. Gradually navigating outward back to a top level after a certain amount of time
b. Leveraging timer parameters to automatically navigating inward to a module
c. Adjusting the inward and outward navigation level based on events -or lack of events- from physical interfaces such as mouse track wheel, mouse movements, keyboard entries, or retina interfaces
d. Triggering inward and outward navigation level adjustments automatically and continuously

4. A system according to claim 2 including means to fragment content into components to be displayed in the modules.

5. The system of claim 2 including means to display said content via one or more virtual projections onto one or more three-dimensional objects.

6. A system according to claim 5 where said three-dimensional objects can be animated automatically or via user action.

7. A system according to claim 6 where said three-dimensional objects can be replaced by objects of four or more dimensions.

8. The system of claim 2 including means to adapt modules and their content to users' habits, preferences, or configurations.

9. A system according to claim 2 including provisions to leverage some modules for constant reference and display.

10. The system of claim 1 where modules reuse screen real-estate within the main display window according to the inward and outward navigation.

11. A system according to claim 2 including means to display and animate content in different modules simultaneously.

12. A system according to claim 2 including means to link a subset of the modules to a context such as geographical, personal, social, technical, or cultural.

13. A system according to claim 2 where arrangements of content may include relationships linking a lower level item back to a top level item therefore giving the user the impression of a circular navigation.

14. The system of claim 1 including a provision for implementation using a multi-tier computerized system architecture.

15. The system of claim 1 including a provision for implementation using client side functionality.

16. The system of claim 1 including a provision for implementation using the internet, web browsers, and related technologies.

17. A system according to claim 2 in which modules and content are stored in a repository made up of one or more databases and one or more file systems.
